(19) United States
(12) Patent Application Publication
(10) Pub. No.: US 2015/0316227 A1
(43) Pub. Date: Nov. 5, 2015

(54) STACKED LIGHTGUIDE TAILIGHT ARTICLE

(71) Applicant: 3M INNOVATIVE PROPERTIES COMPANY, Saint Paul, MN (US)

(72) Inventors: Jennifer J. Sahlin, Minneapolis, MN (US); Scott M. Schnobrich, Stillwater, MN (US); Jeremy K. Larsen, Farmington, MN (US); Michael E. Griffin, Maplewood, MN (US); Bing Hao, Woodbury, MN (US); Karl A. Vick, Elko, MN (US); David A. Ender, New Richmond, WI (US)

(73) Assignee: 3M INNOVATIVE PROPERTIES COMPANY

(21) Appl. No.: 14/649,572

(22) PCT Filed: Dec. 11, 2013
(86) PCT No.: PCT/US2013/074263

§ 371 Date: Jun. 4, 2015

Related U.S. Application Data
(60) Provisional application No. 61/746,718, filed on Dec. 28, 2012.

(51) Int. Cl. F21S 8/10; F21V 8/00; B60Q 1/44; B60Q 1/30

(52) U.S. Cl. CPC F21S 48/2243; F21S 48/2225; F21S 48/2281; F21S 48/2268; B60Q 1/30; G02B 6/0076; G02B 6/0036; B60Q 1/44

(57) ABSTRACT

A taillight article (100) including at least two optically clear light guides (110, 130) stacked on each other to provide vehicle signal function is described. The taillight article comprises a first optically clear light guide (110) having a light emission front surface (112) and an opposing rear surface (114) and a side surface (118) separating the front surface (112) and the rear surface (114), and a plurality of light extraction features (116) on or within the first optically clear light guide (110), the light extraction features (116) configured to direct light out through the emission surface (112); a second optically clear light guide (130) having an light emission front surface (132) and an opposing rear surface (134) and a side surface (138) separating the front surface (132) and the rear surface (134) and a plurality of light extraction features (136) on or within the second optically clear light guide (130), the light extraction features (136) configured to direct light out through the emission surface (132) a first low index layer (150) separating the rear surface (114) of the first optically clear light guide (110) from the front surface (132) of the second optically clear light guide (130), the first low index layer (150) having an index of refraction being less than an index of refraction of the first optically clear light guide (110) and the second optically clear light guide (130); a first light source (120) configured to direct light into the side surface (118) of the first optically clear light guide (110), the first light source (120) indicating a first signal function; a second light source (140) configured to direct light into the side surface of the second optically clear light guide (130), the second light source (140) indicating a second signal function; and a light reflection element (160), where the second optically clear light guide (130) is disposed between the first optically clear light guide (110) and the light reflection element (160).

### FIELD

The disclosure relates to taillight articles and particularly to taillight articles that include at least two optically clear light guides stacked on each other to provide vehicle signal function.

### BACKGROUND

The automotive industry has recently been adopting LED technology in tail light, head light, and other signal light applications. In some cases, a combination of LED and incandescent technology is used. In other cases, lamps use solely LEDs as sources. Tail lamps with tens or even more than a hundred LEDs are observed. In general, free-space optics have been used. Disadvantages with such an approach include the need for large cavities requiring more trunk space and the additional indirect cost associated with the generally necessary metal-working of the vehicle frame housing the lamp.

More recently, solid light guides have been proposed for the rear running light or for cosmetic purposes. In general, these solid light guides have introduced the challenges of being bulky, heavy, and not especially uniform in their light emission without the use of other optical elements such as diffusers. Such optical elements add additional complexity, cost and reduce light brightness.

From a decorative stand-point, LEDs are point sources that are easily resolved at standard viewing distances. LEDs have been used in direct lit signal functions, however this point light source appearance may not be appealing to a viewer due to brightness, glare and other reasons. In addition, vehicle tail lamp assemblies contain multiple signal functions. Each of these signal functions has unique color, uniformity, and intensity requirements. The running light, which is operational during vehicle operation at night, is generally red or red-amber light. The stop light, which is activated intermittently, is often the same color as the running light but is generally more intense. The back-up light is generally white light and finally, the signal light, is generally either yellow, amber or red light.

### BRIEF SUMMARY

The disclosure relates to taillight articles and particularly to taillight articles that include at least two optically clear light guides stacked on each other to provide vehicle signal function. Each optically clear light guide can provide a different signal function. This stacked taillight article can form a single monolithic article with a thin form factor that can include aesthetic features that are observable through the optically clear light guides, especially in an “off” state.

In one aspect of the disclosure, a taillight article includes a first optically clear light guide having a light emission front surface, an opposing rear surface, and a side surface separating the front surface and the rear surface. A plurality of light extraction features are positioned on or within the first optically clear light guide. The light extraction features are configured to direct light out through the emission surface. A second optically clear light guide has a light emission front surface and an opposing rear surface and a side surface separating the front surface and the rear surface and a plurality of light extraction features are positioned on or within the second optically clear light guide. The light extraction features are configured to direct light out through the emission surface. A first low index layer separates the rear surface of the first optically clear light guide from the front surface of the second optically clear light guide. The first low index layer has an index of refraction being less than an index of refraction of the first optically clear light guide and the second optically clear light guide. A first light source is configured to direct light into the side surface of the first optically clear light guide. The first light source indicates a first signal function. A second light source is configured to direct light into the side surface of the second optically clear light guide. The second light source indicates a second signal function. A light reflection element is disposed adjacent the rear surface of the second light guide and the second optically clear light guide is disposed between the first optically clear light guide and the light reflection element.

In one or more embodiments, the first optically clear light guide plurality of light extraction features are disposed on or adjacent to the rear surface of the first optically clear light guide and the second optically clear light guide plurality of light extraction features are disposed on or adjacent to the rear surface of the second optically clear light guide. In one or more embodiments, light emitted from the second optically clear light guide emission surface transmits through the first optically clear light guide. In one or more embodiments, the first light source is configured to direct a first colored light into the first optically clear light guide side surface and the second light source is configured to direct a second colored light into the second optically clear light guide side surface, and the first colored light is a different color than the second colored light.

In one or more embodiments, the first optically clear light guide and the second optically clear light guide are curved. In some of these embodiments, the first optically clear light guide plurality of light extraction features are disposed on or adjacent to the front surface of the first optically clear light guide, or on or adjacent to the rear surface of the first optically clear light guide, or both, depending on the requirements for the angular distribution of the emission.

In one or more embodiments, the first optically clear light guide light extraction features have a feature size in a range from 5 to 750 micrometers. In one or more embodiments, the second optically clear light guide light extraction features have a feature size in a range from 5 to 1500 micrometers.

In one or more embodiments, the taillight article further includes a third optically clear light guide having a light emission front surface, a light extraction rear surface, and a side surface separating the front surface and the rear surface and a plurality of light extraction features positioned on or adjacent to the rear surface, the light extraction features configured to direct light out through the emission surface. A second low index layer separates the rear surface of the second optically clear light guide from the front surface of the third optically clear light guide. The second low index layer has an index of refraction being less than the index of refraction of both the second optically clear light guide and the third optically clear light guide. A third light source is configured to direct light into the side surface of the third optically clear light guide. The third light source indicates a third signal function, and light emitted from the third optically clear light guide transmits through the first and second optically clear light guides.

In one or more embodiments, the light reflection element reflects at least 70% or at least 90% of incident light. In one or more embodiments, the taillight article is a laminate monolithic construction. In one or more embodiments, the light reflection element includes indicia or a graphical element that is observable by a viewer. In one or more embodiments, the taillight article has a total thickness in a range from 0.2 to 2 cm. In one or more embodiments, the low index layer is an air gap. In one or more embodiments, an adhesive is disposed on a rear surface of the taillight article, the adhesive is configured to fix the taillight article to a vehicle. In one or more embodiments, the light reflection element is colored.

In one or more embodiments, the first signal function and the second signal function are different signal functions. In one or more embodiments, the first signal function is a running light function and the second signal function is a braking light function. In one or more embodiments, the first signal function, second signal function and third signal functions are different signal functions selected from the group consisting of a running light function, a turning signal function, a braking signal function, and a back-up signal function. In one or more embodiments, portions of the any one optically clear light guide emission surface are not covered by any or all of the other optically clear light guides in the stack.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic perspective view of a vehicle with illustrative taillights;

FIG. 2 is a schematic cross-sectional view of an illustrative taillight;

FIG. 3 is a schematic cross-sectional view of another illustrative taillight;

FIG. 4 is a schematic cross-sectional view of a curved illustrative taillight;

FIG. 5 is a schematic perspective view of an illustrative light extraction feature; and

FIG. 6 is a schematic perspective view of another illustrative light extraction feature.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The term “optically clear” refers to an element being transparent to a viewer so that a viewer can easily discern what the optically clear element is separating from the viewer. Visible light can transmit through an optically clear element. In many embodiments, an optically clear element is colorless such as clear glass. Extractors or extraction features may be present in an optically clear region, but their density and size are small enough to enable optical clarity, as described below.

The term “signal function” refers to a light indication of a running light indication, a braking light indication, a back-up light indication or a turning light indication.

The term “light source” refers to one or more single point sources or a plurality of light sources that inject light into a single light guide.

The disclosure relates to taillight articles and particularly to taillight articles that includes at least two optically clear light guides stacked on each other to provide vehicle signal function. Each optically clear light guide can provide a different signal function. This stacked taillight article can form a single monolithic article with a thin form factor that can include aesthetic features that are observable through the optically clear light guides, especially in an “off” state, among other aspects. The optically clear light guides and corresponding taillight article can be curved and emit light uniformly along the curved and non-curved portions of the optically clear light guides. While the present disclosure is not so limited, an appreciation of various aspects of the disclosure will be gained through a discussion of the examples provided below.

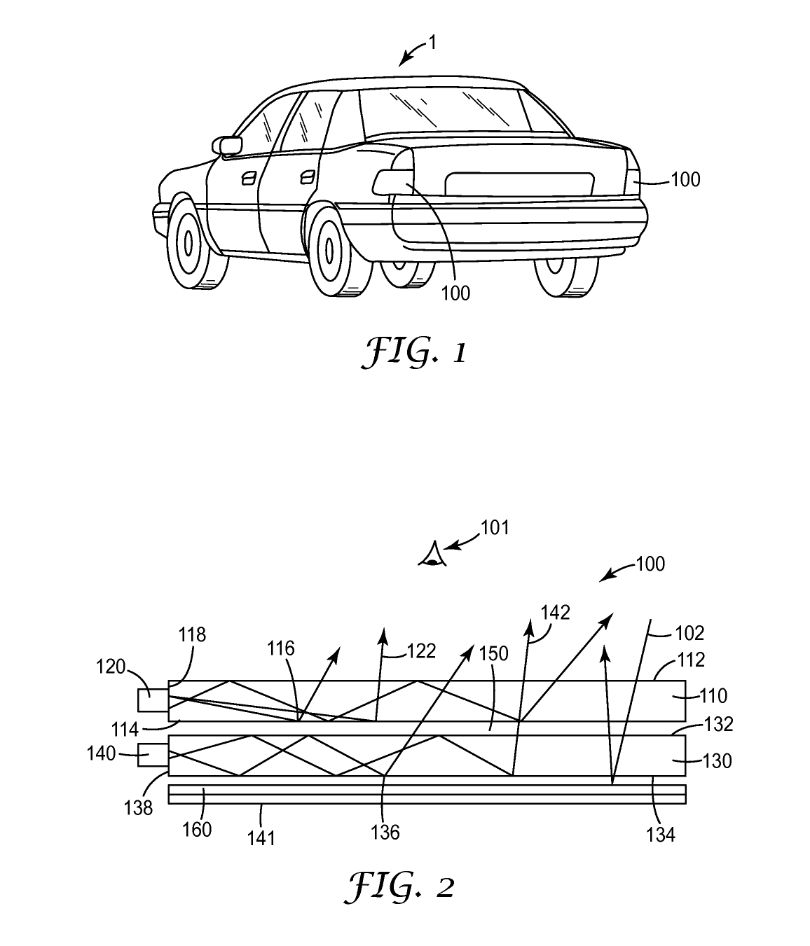

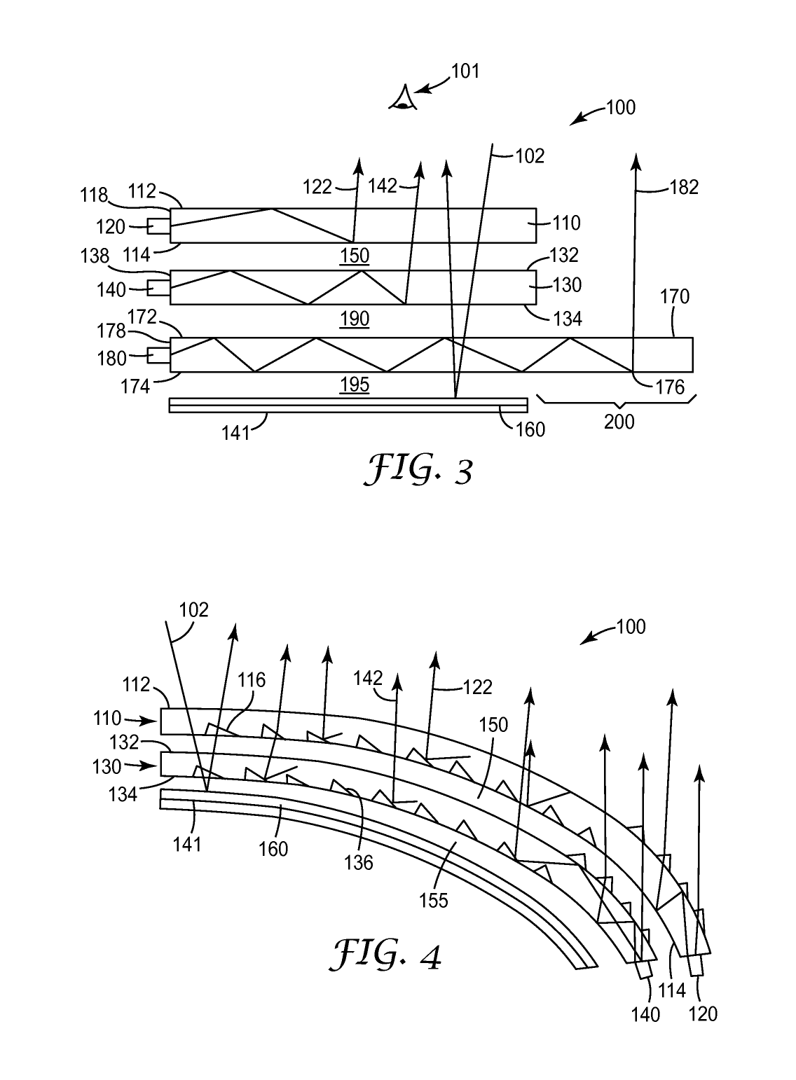

FIG. 1 is a schematic perspective view of a vehicle 1 with illustrative taillights 100. FIG. 2 is a schematic cross-sectional view of an illustrative taillight 100. FIG. 3 is a schematic cross-sectional view of another illustrative taillight 100. FIG. 4 is a schematic cross-sectional view of a curved illustrative taillight 100. While the taillight article 100 is illustrated as a rectangular element on the rear of a vehicle 1, it is understood that the taillight article 100 can have any useful shape and be placed in any useful location on a vehicle. For example, in the case of a curved taillight, such as the taillight illustrated in FIG. 4, the taillight may curve around the back corners of the vehicle, such that a portion of the taillight is co-planar or near co-planar with the back of the car, and a portion of the taillight is co-planar or near co-planar with the side of the car.

In one or more embodiments, a taillight article 100 includes a first optically clear light guide 110 having an light emission front surface 112 and an opposing rear surface 114 and a side surface 118 separating the front surface 112 and the rear surface 114. A plurality of light extraction features 116 are on or within the first optically clear light guide 110. The light extraction features 116 are configured to direct light 122 out through the emission surface 112.

A second optically clear light guide 130 has an light emission front surface 132 and an opposing rear surface 134 and a side surface 138 separating the front surface 132 and the rear surface 134 and a plurality of light extraction features 136 on or within the second optically clear light guide 130. The light extraction features 136 are configured to direct light 142 out through the emission surface 132 of the lightguide.

A first low index layer 150 separates the rear surface 114 of the first optically clear light guide 110 from the front surface 132 of the second optically clear light guide 130. The first low index layer 150 has an index of refraction that is less than an index of refraction of the first optically clear light guide 110 and the second optically clear light guide 130. In one or more embodiments the first low index layer 150 is an air gap.

A first light source 120 is configured to direct light into the side surface 118 of the first optically clear light guide 110. The first light source 120 indicates a first signal function. A second light source 140 is configured to direct light into the side surface 138 of the second optically clear light guide 130. The second light source 140 indicates a second signal function. In one or more embodiments, one or more light sources are disposed behind the stacked light guide to provide a direct lit signal function. This direct lit signal function transmits through the optical light guides and is observed by a viewer. In some of these embodiments, the direct lit signal function is a back-up signal function and/or a braking signal function.

As illustrated in FIG. 2 and FIG. 4, a light reflection element 160 is disposed adjacent the rear surface 134 of the second light guide 130 and the second optically clear light guide 130 is disposed between the first optically clear light guide 110 and the light reflection element 160. The light reflection element 160 can be a specular or diffuse surface, a colored surface and/or include indicia or a graphical element that is observable by a viewer.

Visible light 102 can transmit through the optically clear light guides 110, 130, 170 so that a viewer 101 can discern the light reflection element 160 of the taillight article 100. In one or more embodiments indicia or graphical elements can be disposed on or within the light reflection element 160 of the taillight article 100. The visible light 102 can transmit through the optically clear light guides 110, 130, 170 from the external environment, and reflect off the indicia or graphical elements and return back to a viewer 101 such that a viewer 101 can observe the indicia or graphical elements on or within the light reflection element 160 of the taillight article 100. Indicia or graphical elements can be any useful indicia or graphical elements that provide a structured, faceted or jewel-like appearance, for example. In some embodiments, the indicia may be a brand or model name for a vehicle.

The optically clear light guides 110, 130, 170 can be flat or planar as illustrated in FIG. 2 and FIG. 3 or curved as illustrated in FIG. 4. When the first and second optically clear light guides are curved, at least a portion of the first optically clear light guide 110 plurality of light extraction features 116 may be disposed on or adjacent to the front surface 112 of the first optically clear light guide 110. In some of these embodiments, at least a portion of the second optically clear light guide 130 plurality of light extraction features 136 may be disposed on or adjacent to the front surface 132 of the second optically clear light guide 130.

In one or more embodiments, the first optically clear light guide 110 plurality of light extraction features 116 are disposed on or adjacent to the rear surface of the first optically clear light guide 110 and the second optically clear light guide 130 plurality of light extraction features 136 are disposed on or adjacent to the rear surface 134 of the second optically clear light guide 130. In one or more embodiments, light 142 emitted from the second optically clear light guide 130 emission surface 132 transmits through the first optically clear light guide 110.

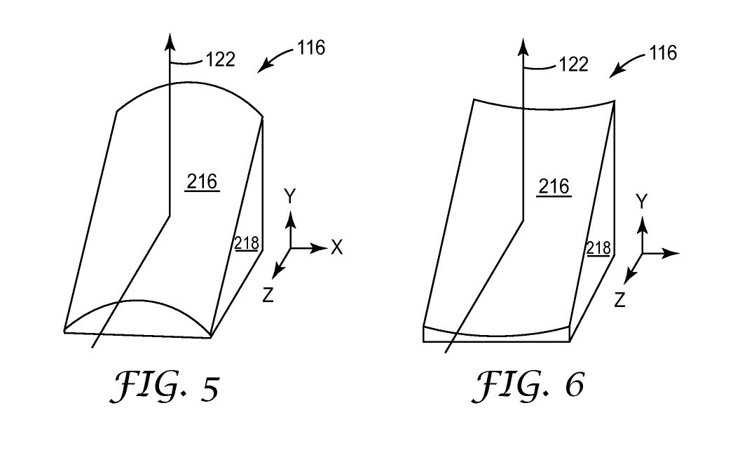

FIG. 5 is a schematic perspective view of an illustrative light extraction feature 116 (and applied equally to the light extraction feature 136 and 176). FIG. 6 is a schematic perspective view of another illustrative light extraction feature 116 (and applied equally to the light extraction elements 136 and 176). The extraction features can have any useful shape that will direct light out of the optically clear light guide. In one or more embodiments the extraction features are generally not discernible under observation from a viewer 101. In many embodiments the extraction features are patterned to provide uniform illumination along an entire lateral dimension of the optically clear light guide from the light source. In some embodiments, the light extraction features form a pattern shaped as indicia or a graphical element that is observable by a viewer.

For purposes of this description, where a direction corresponds to a provided axis of a coordinate system (see FIG. 5 and FIG. 6), for example the y-axis, it may be referred to as, e.g., “the y-direction.” The z-direction is perpendicular to the x-direction along which the light guide emission surface extends. The y-direction is perpendicular to the x-direction and z-direction and extends in an out-of-plane direction from the light guide emission surface.

In order to direct signal function light along the y-direction that is initially generally propagated along the z-direction, it is necessary to appropriately choose proper light extraction element shape, orientation, and potentially spacing. A number of different shapes of light extraction elements are contemplated in the present description, for example, the light extraction features may be prisms, cones, aspheric cones, truncated prisms, cones, aspheric cones, wedges, hemispheres, conic sections, or truncated conic sections. A further description of these shapes and other appropriate light extraction features, as well as potential method of making such shapes may be found in commonly owned U.S. Pat. No. 7,941,013 (Martilla et al.), the relevant portions of which are hereby incorporated by reference. A method of forming the appropriate light extraction features is also described in commonly owned U.S. Patent Application Publication No. 2012/0126038 (Carpenter et al.), the relevant portions of which are hereby incorporated by reference.

In one or more embodiments, the light extraction features may be insert wedges, as illustrated in FIG. 5 and FIG. 6. The wedge shown in FIG. 5 is a wedge having negative cylindrical sag. The wedge shown in FIG. 6 is a wedge having positive cylindrical sag. Both of these shapes are contemplated as appropriate light extractor shapes in the present description. These light extraction features project into the solid light guide.

It is also important to properly orient the light extraction feature with respect to the incident light from the appropriate light source. This provides the selective extraction of light desired in the present description. A facet or light reflection face 216 faces the first light source 120, for example, (along a z-direction for example) and reflects signal function light 122 emitted from the first light source 120 along a y-direction (for example) and out of the optically clear light guide 110. Light that is incident on a side surface 218, or any surface other than the facet or light reflection face 216 will not substantially reflect light 122 in the y-direction and direct light 122 out of the optically clear light guide 110.

In one or more embodiments, the light extraction features 116 have a feature size (e.g., largest lateral dimension) in a range from 5 to 750 micrometers or from 30 to 600 micrometers. In one or more embodiments, the second optically clear light guide 130 light extraction features 136 have a feature size (e.g., largest lateral dimension) in a range from 5 to 750 micrometers or from 30 to 600 micrometers. In one or more embodiments, the third optically clear light guide 170 light extraction features 176 have a feature size (e.g., largest lateral dimension) in a range from 5 to 1500 micrometers or from 30 to 1000.

In general, the extraction efficiency should increase as distance from the light source increases to maintain uniform extraction across the top surface of the light guide. In some embodiments the light extraction features increase in size as a distance from the light source increases. In some embodiments, extractor efficiency is increased by orientation, positioning, or increasing the density of the light extraction features, or other means.

Proper sizing and spacing of light extraction features provides an “optically clear” appearance. In one or more embodiments the light extraction features have a feature size (i.e., largest lateral dimension) in a range from 5 to 600 micrometers and an average spacing (i.e., minimum lateral distance) in a range from 125 to 725 micrometers, where smaller light extraction features may be spaced further from one another than larger light extraction features. In one or more embodiments the light extraction features have a feature size (i.e., largest lateral dimension) in a range from 20 to 450 micrometers and an average spacing (ie., minimum lateral distance) in a range from 125 to 725 micrometers. In one or more embodiments the light extraction features have a feature size (i.e., largest lateral dimension) in a range from 30 to 350 micrometers and an average spacing (ie., minimum lateral distance) in a range from 125 to 725 micrometers. In some embodiments, a portion of the light extraction features may be visible to a viewer 101 and can have a size in a range from 3000 to 6000 micrometers.

In one or more embodiments, the first light source 120 is configured to direct a first colored light 122 into the first optically clear light guide 110 side surface 118 and the second light source 140 is configured to direct a second colored light 142 into the second optically clear light guide 130 side surface 138, and the first colored light 122 is a different color than the second colored light 142.

In one or more embodiments, the first optically clear light guide is disposed over only a portion of the second optically clear light guide (not shown). Thus, light emitted from the second optically clear light guide can transmit through the first optically clear light guide over a first portion of the second optically clear light guide and can be directly emitted from the taillight article over a second portion of the second optically clear light guide. In one or more embodiments, the second optically clear light guide is disposed under only a portion of the first optically clear light guide.

In one or more embodiments, the taillight article 100 further includes a third optically clear light guide 170 having an light emission front surface 172 and a light extraction rear surface 174 and a side surface 178 separating the front surface 172 and the rear surface 174 and a plurality of light extraction features 176 on or adjacent to the rear surface 174. The light extraction features 176 are configured to direct light 182 out through the emission surface 182.

A second low index layer 190 separates the rear surface 134 of the second optically clear light guide 130 from the front surface 172 of the third optically clear light guide 170. The second low index layer 190 has an index of refraction being less than the index of refraction of both the second optically clear light guide 130 and the third optically clear light guide 170.

A third light source 180 is configured to direct light 182 into the side surface 178 of the third optically clear light guide 170. The third light source 180 indicates a third signal function, and light emitted 182 from the third optically clear light guide 170 transmits through the first and second optically clear light guides 110, 130.

As illustrated in FIG. 3, an exposed portion 200 of the third optically clear light guide 170 is not overlaid by the first optically clear light guide 110 and second optically clear light guide 130. In many of these embodiments, the third signal function can be emitted from only the exposed portion 200 of the third optically clear light guide 170. For example, the third signal function can be a turning signal function. In one exemplary embodiment, the first signal function is a running light function, the second signal function is a braking signal function and the third signal function can be a turning signal function.

It is understood that a fourth light guide and corresponding fourth light source (not shown) can be included in the taillight article and can provide a fourth signal function. The four light guides can be stacked on top of each other and separated by a low index layer and forming a laminate taillight article. In these embodiments, each of the four light guides can display a separate signal function selected from the group consisting of a running light function, a turning signal function, a braking signal function, and a back-up signal function.

The taillight article having two, three or four stacked light guides can have substantially the same physical dimensions or one or more of the two, three or four stacked light guides can have different physical dimensions and have light emission zones that may or may not overlap with emission zones in the other light guides that form the taillight article.

In one or more embodiments the light reflection element 160 is a mirror film or a vapor coated metal layer. The light reflection element 160 can reflect at least 70% or at least 90% of incident light 102. In one or more embodiments, the light reflection element 160 is colored, for example to match a color of the exterior of the vehicle 1. In one or more embodiments, the light reflection element 160 includes indicia or a graphical element that is observable by a viewer. Indicia or graphical elements can be any useful indicia or graphical elements including some that provide a structured, faceted or jewel-like appearance, for example. In one or more embodiments, during an “off-state” (e.g., when the taillight 100 is not indicating a signal function) the light reflection element 160 can provide a perception of “depth” to its appearance and/or the indicia or graphical elements may all be observed by a viewer to provide unique aesthetic features.

In one or more embodiments, the taillight article 100 is a laminate monolithic construction. In one or more embodiments, the taillight article 100 has a total thickness in a range from 0.2 to 2 cm or from 0.2 to 10 cm.

In one or more embodiments, the first low index layer and second low index layers 150, 190 are both air gaps. In one or more embodiments, the first low index layer and second low index layers 150, 190 have an index of refraction that is at least 0.1 less than the index of refraction of the first, second and third optically clear light guides 110, 130, 170.

In one or more embodiments a third low index layer 195 separates the third optically clear light guide 170 from the light reflection element 160. In one or more embodiments, the third low index layer 195 is an air gap. In one or more embodiments, the third low index layer 195 has an index of refraction that is at least 0.1 less than the index of refraction of the third optically clear light guide 170.

In one or more embodiments, an adhesive 141 is disposed on a rear surface of the taillight article 100, the adhesive 141 is configured to fix the taillight article 100 to a vehicle 1. In many embodiments the adhesive 141 is a pressure sensitive adhesive.

In one or more embodiments, the first signal function and the second signal function are different signal functions. In one or more embodiments, the first signal function is a running light function and second signal function is a braking light function.

In one or more embodiments, the first signal function, second signal function and third signal functions are different signal functions selected from the group consisting of a running light function, a turning signal function, a braking signal function, and a back-up signal function.

In one or more embodiments, the first signal function, second signal function, third signal function, and fourth signal function are different signal functions selected from the group consisting of a running light function, a turning signal function, a braking signal function, and a back-up signal function.

The following is a list of items of the present disclosure:

Item 1 is a taillight article comprising:
a first optically clear light guide having a light emission front surface and an opposing rear surface and a side surface separating the front surface and the rear surface, and a plurality of light extraction features on or within the first optically clear light guide, the light extraction features configured to direct light out through the emission surface;
a second optically clear light guide having an light emission front surface and an opposing rear surface and a side surface separating the front surface and the rear surface and a plurality of light extraction features on or within the second optically clear light guide, the light extraction features configured to direct light out through the emission surface;
a first low index layer separating the rear surface of the first optically clear light guide from the front surface of the second optically clear light guide, the first low index layer having an index of refraction being less than an index of refraction of the first optically clear light guide and the second optically clear light guide;
a first light source configured to direct light into the side surface of the first optically clear light guide, the first light source indicating a first signal function;
a second light source configured to direct light into the side surface of the second optically clear light guide, the second light source indicating a second signal function; and
a light reflection element, where the second optically clear light guide is disposed between the first optically clear light guide and the light reflection element.

Item 2 is a taillight article according to item 1, wherein the first optically clear light guide plurality of light extraction features are disposed on or adjacent to the rear surface of the first optically clear light guide and the second optically clear light guide plurality of light extraction features are disposed on or adjacent to the rear surface of the second optically clear light guide.

Item 3 is a taillight article according to any of the preceding items, wherein light emitted from the second optically clear light guide emission surface transmits through the first optically clear light guide.

Item 4 is a taillight article according to any of the preceding items, wherein the first light source is configured to direct a first colored light into the first optically clear light guide side surface and the second light source is configured to direct a second colored light into the second optically clear light guide side surface, and the first colored light is a different color than the second colored light.

Item 5 is a taillight article according to any of the preceding items, wherein the first optically clear light guide and the second optically clear light guide are curved.

Item 6 is a taillight article according to claim 5, wherein a portion of the first optically clear light guide plurality of light extraction features are disposed on or adjacent to the front surface of the first optically clear light guide.

Item 7 is a taillight article according to any of the preceding items, wherein the first signal function and second signal function are different signal functions.

Item 8 is a taillight article according to any of the preceding items, wherein the first signal function is a running light function and second signal function is a braking light function.

Item 9 is a taillight article according to any of the preceding items, further comprising:
a third optically clear light guide having an light emission front surface and a light extraction rear surface and a side surface separating the front surface and the rear surface and a plurality of light extraction features on or adjacent to the rear surface, the light extraction features configured to direct light out through the emission surface;
a second low index layer separating the rear surface of the second optically clear light guide from the front surface of the third optically clear light guide, the second low index layer having an index of refraction being less than an index of refraction of either the second optically clear light guide or the third optically clear light guide; and
a third light source configured to direct light into the side surface of the third optically clear light guide, the third light source indicating a third signal function, and light emitted from the third optically clear light guide transmits through the first and second optically clear light guides;
wherein the third optically clear light guide is disposed between the second optically clear light guide and the light reflection element.

Item 10 is a taillight article according to any of the preceding items, further comprising:
a fourth optically clear light guide having an light emission front surface and a light extraction rear surface and a side surface separating the front surface and the rear surface and a plurality of light extraction features on or adjacent to the rear surface, the light extraction features configured to direct light out through the emission surface; and
a third low index layer separating the rear surface of the third optically clear light guide from the front surface of the fourth optically clear light guide, the third low index layer having an index of refraction being less than an index of refraction of either the third optically clear light guide or the fourth optically clear light guide;
wherein the fourth optically clear light guide is disposed between the third optically clear light guide and the light reflection element.

Item 11 is a taillight article according to any of the preceding items, wherein the optically clear light guide light extraction features have a feature size in a range from 5 to 750 micrometers.

Item 12 is a taillight article according to any of the preceding items, wherein the optically clear light guide light extraction features have a feature size in a range from 30 to 600 micrometers.

Item 13 is a taillight article according to any of the preceding items, wherein an inner-most light guide light has extraction features in a size range from 5 to 1500 micrometers.

Item 14 is a taillight article according to any of the preceding items, wherein the light reflection element reflects at least 90% of incident light.

Item 15 is a taillight article according to any of the preceding items, wherein the taillight article is a laminate monolithic construction.

Item 16 is a taillight article according to any of the preceding items, wherein the light reflection element comprises indicia or a graphical element that is observable by a viewer.

Item 17 is a taillight article according to any of the preceding items, wherein the taillight article has a total thickness in a range from 0.2 to 2 cm.

Item 18 is a taillight article according to any of the preceding items, wherein one or more of the low index layers are air gaps.

Item 19 is a taillight article according to any of the preceding items, wherein the first optically clear light guide and the second optically clear light guide and the third optically clear light guide are curved.

Item 20 is a taillight article according to item 19 wherein a portion of the first optically clear light guide and the second optically clear light guide and the third optically clear light guide plurality of light extraction features are disposed on or adjacent to the front surface of the first optically clear light guide.

Item 21 is a taillight article according to any of the preceding items, wherein an adhesive is disposed on a rear surface of the taillight article, the adhesive being configured to fix the taillight article to a vehicle.

Item 22 is a taillight article according to any of the preceding items, wherein the light reflection element is colored.

Item 23 is a taillight article according to item 9, wherein the first signal function, second signal function and third signal functions are different signal functions selected from the group consisting of a running light function, a turning signal function, a braking signal function, and a back-up signal function.

Item 24 is a taillight article according to item 10, wherein the first signal function, second signal function, third signal function, and fourth signal function are different signal functions selected from the group consisting of a running light function, a turning signal function, a braking signal function, and a back-up signal function.

Item 25 is a taillight article according to any of the preceding items, wherein at least a portion of one or more of the optically clear light guide emission surfaces are not covered by one or more adjacent optically clear light guides.

Item 26 is a taillight article according to any of the preceding items, wherein the light extraction features form a pattern shaped as indicia or a graphical element that is observable by a viewer.

Item 27 is a taillight article according to any of the preceding items, wherein the first optically clear light guide light extraction features emit light in a direction that is different than a direction of light emitted from the second optically clear light guide light extraction features.

Item 28 is a taillight article according to any of the preceding items, further comprising a direct lit light source transmitting light through the optically clear light guides.

Embodiments of the present disclosure are disclosed. The disclosed embodiments are presented for purposes of illustration and not limitation. The implementations described above and other implementations are within the scope of the following claims. One skilled in the art will appreciate that the present disclosure can be practiced with embodiments other than those disclosed. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the present disclosure. The scope of the present application should, therefore, be determined only by the following claims.

1. A taillight article comprising:
a first optically clear light guide having a light emission front surface and an opposing rear surface and a side surface separating the front surface and the rear surface, and a plurality of light extraction features on or within the first optically clear light guide, the light extraction features configured to direct light out through the emission surface;
a second optically clear light guide having an light emission front surface and an opposing rear surface and a side surface separating the front surface and the rear surface and a plurality of light extraction features on or within the second optically clear light guide, the light extraction features configured to direct light out through the emission surface;
a first low index layer separating the rear surface of the first optically clear light guide from the front surface of the second optically clear light guide, the first low index layer having an index of refraction being less than an index of refraction of the first optically clear light guide and the second optically clear light guide;
a first light source configured to direct light into the side surface of the first optically clear light guide, the first light source indicating a first signal function;
a second light source configured to direct light into the side surface of the second optically clear light guide, the second light source indicating a second signal function; and
a light reflection element, where the second optically clear light guide is disposed between the first optically clear light guide and the light reflection element.

2-10. (canceled)

11. A taillight article according to claim 1, wherein the first optically clear light guide plurality of light extraction features are disposed on or adjacent to the rear surface of the first optically clear light guide and the second optically clear light guide plurality of light extraction features are disposed on or adjacent to the rear surface of the second optically clear light guide.

12. A taillight article according to claim 1, wherein light emitted from the second optically clear light guide emission surface transmits through the first optically clear light guide.

13. A taillight article according to claim 1, wherein the first light source is configured to direct a first colored light into the first optically clear light guide side surface and the second light source is configured to direct a second colored light into the second optically clear light guide side surface, and the first colored light is a different color than the second colored light.

14. A taillight article according to claim 1, wherein the first optically clear light guide and the second optically clear light guide are curved.

15. A taillight article according to claim 14, wherein a portion of the first optically clear light guide plurality of light extraction features are disposed on or adjacent to the front surface of the first optically clear light guide.

16. A taillight article according to claim 1, wherein the first signal function and second signal function are different signal functions.

17. A taillight article according to claim 1, wherein the first signal function is a running light function and second signal function is a braking light function.

18. A taillight article according to claim 1, further comprising:
a third optically clear light guide having an light emission front surface and a light extraction rear surface and a side surface separating the front surface and the rear surface and a plurality of light extraction features on or adjacent to the rear surface, the light extraction features configured to direct light out through the emission surface;
a second low index layer separating the rear surface of the second optically clear light guide from the front surface of the third optically clear light guide, the second low index layer having an index of refraction being less than an index of refraction of either the second optically clear light guide or the third optically clear light guide; and
a third light source configured to direct light into the side surface of the third optically clear light guide, the third light source indicating a third signal function, and light emitted from the third optically clear light guide transmits through the first and second optically clear light guides;
wherein the third optically clear light guide is disposed between the second optically clear light guide and the light reflection element.

19. A taillight article according to claim 1, further comprising:
a fourth optically clear light guide having an light emission front surface and a light extraction rear surface and a side surface separating the front surface and the rear surface and a plurality of light extraction features on or adjacent to the rear surface, the light extraction features configured to direct light out through the emission surface; and
a third low index layer separating the rear surface of the third optically clear light guide from the front surface of the fourth optically clear light guide, the third low index layer having an index of refraction being less than an index of refraction of either the third optically clear light guide or the fourth optically clear light guide;
wherein the fourth optically clear light guide is disposed between the third optically clear light guide and the light reflection element.

20. A taillight article according to claim 1, wherein the optically clear light guide light extraction features have a feature size in a range from 5 to 750 micrometers.

21. A taillight article according to claim 1, wherein the optically clear light guide light extraction features have a feature size in a range from 30 to 600 micrometers.

22. A taillight article according to claim 1, wherein an inner-most light guide light has extraction features in a size range from 5 to 1500 micrometers.

23. A taillight article according to claim 1, wherein the light reflection element reflects at least 90% of incident light.

24. A taillight article according to claim 1, wherein the taillight article is a laminate monolithic construction.

25. A taillight article according to claim 1, wherein the light reflection element comprises indicia or a graphical element that is observable by a viewer.

26. A taillight article according to claim 1, wherein the taillight article has a total thickness in a range from 0.2 to 2 cm.

27. A taillight article according to claim 1, wherein one or more of the low index layers are air gaps.

28. A taillight article according to claim 1, wherein the first optically clear light guide and the second optically clear light guide and the third optically clear light guide are curved.

29. A taillight article according to claim 28 wherein a portion of the first optically clear light guide and the second optically clear light guide and the third optically clear light guide plurality of light extraction features are disposed on or adjacent to the front surface of the first optically clear light guide.

30. A taillight article according to claim 1, wherein an adhesive is disposed on a rear surface of the taillight article, the adhesive being configured to fix the taillight article to a vehicle.

31. A taillight article according to claim 1, wherein the light reflection element is colored.

32. A taillight article according to claim 18, wherein the first signal function, second signal function and third signal functions are different signal functions selected from the group consisting of a running light function, a turning signal function, a braking signal function, and a back-up signal function.

33. A taillight article according to claim 19, wherein the first signal function, second signal function, third signal function, and fourth signal function are different signal functions selected from the group consisting of a running light function, a turning signal function, a braking signal function, and a back-up signal function.

34. A taillight article according to claim 1, wherein at least a portion of one or more of the optically clear light guide emission surfaces are not covered by one or more adjacent optically clear light guides.

35. A taillight article according to claim 1, wherein the light extraction features form a pattern shaped as indicia or a graphical element that is observable by a viewer.

36. A taillight article according to claim 1, wherein the first optically clear light guide light extraction features emit light in a direction that is different than a direction of light emitted from the second optically clear light guide light extraction features.

37. A taillight article according to claim 1, further comprising a direct lit light source transmitting light through the optically clear light guides.
